(19) United States
(12) Patent Application Publication
(10) Pub. No.: US 2006/0120106 A1
(43) Pub. Date: Jun. 8, 2006

(54) Illumination apparatus

(75) Inventors: Heiji Kuki, Yokkaichi-city (JP); Toshiki Oohira, Yokkaichi-city (JP)

Correspondence Address: OLIFF & BERRIDGE, PLC, P.O. BOX 19928, ALEXANDRIA, VA, 22320, US

(73) Assignee: Sumitomo Wiring Systems, Ltd., Mie (JP)

(21) Appl. No.: 11/290,554

(22) Filed: Dec. 1, 2005

(30) Foreign Application Priority Data
Dec. 2, 2004 (JP) 2004-349505

(51) Int. Cl. F21V 7/04

(52) U.S. Cl. 362/608; 362/612; 362/613

(57) ABSTRACT

An illumination apparatus can enhance brightness of illumination while minimizing the number of dot-like light sources. The illumination apparatus includes a light guide plate having side surfaces and a plurality of LEDs disposed on a substrate to direct light to the side surfaces. Incident lights from the LEDs illuminate a front surface of the light guide plate substantially uniformly. The illumination apparatus further includes a holder disposed between the side surface of the light guide plate and the substrate for surrounding the respective LEDs and their light paths together and filler blocks disposed on the substrate to close gaps between adjacent LEDs. The filler blocks reflect a part of the reflected light at least from the light guide plate or the holder.

Patent Application No. JP-2004-349505, filed Dec. 2, 2004 in Japan, is hereby incorporated by reference in its entirety.

### BACKGROUND

This invention relates to an illumination apparatus.

Generally, an illumination apparatus is known in which a plurality of light sources irradiate lights on an incident surface of a light guide plate to illuminate a front surface of the light guide plate substantially uniformly.

Such a kind of illumination apparatus is utilized as, for example, a backlight for a liquid crystal display, as shown in Japanese Laid-Open Patent Application 2003-29248 (JP-A-2003-29248).

In the liquid crystal display, a light guide plate illuminated by lights irradiated from a plurality of light sources mounted on a board illuminates substantially uniformly a liquid crystal panel from its rear side.

### SUMMARY

However, it has been required recently to enhance a cost performance ratio of the illumination apparatus. That is, it has been required in the illumination apparatus to enhance the brightness of illumination without increasing the number of light sources or to decrease the number of the light sources while maintaining the brightness of illumination. It has been difficult to resolve conflicts between the desired number of light sources and the desired brightness of illumination.

In view of the above problems, an object of exemplary embodiments of the present invention is to provide an illumination apparatus that can enhance the brightness of illumination while reducing the number of light sources as low as possible.

In order to solve the above problems, the inventors of the present application have come up with an idea that utilizes a guide member to surround a plurality of light sources and their light paths and that guides irradiated lights through the guide member to an incident surface. Since this can suppress the lights from the light sources that pass outside the guide member, it is possible to reduce the loss of irradiated lights.

Furthermore, the inventors of the present application have ascertained that utilizing even a few light sources can enhance the brightness of illumination (light guide plate) by closing the gap between adjacent light sources. The inventors have considered that lights reflected from the guide member, or the light guide plate, are either absorbed in a board in the interior of the guide member, or enter a gap between the board and the light sources, and that this will cause a loss of light irradiated from the light sources.

Thus, exemplary embodiments of the present invention is directed to an illumination apparatus that includes a light guide plate having an incident surface and a plurality of light sources disposed on a board to direct irradiating lights on the incident surface and incident lights from the light sources illuminate a front surface of the light guide plate substantially uniformly. The illumination apparatus further includes: a guide member disposed between the incident surface of the light guide plate and the board for surrounding the light sources and their light paths together and a spacer member disposed on the board to close a gap between adjacent light sources. The spacer member reflects a part of the reflected light at least from the light guide plate or the guide member, among the light irradiated from the light sources.

Since the spacer member can reflect the light irradiated to a gap between the adjacent light sources and reflected to the guide member or light guide plate, a part of the reflected light can be emitted again to the light guide plate, thereby reducing a loss of the reflected light in the gap between the adjacent light sources.

Accordingly, exemplary embodiments of the present invention can enhance brightness of illumination by fewer light sources.

The words “to close a gap between adjacent light sources” are not limited to the fact that the gap is entirely filled by the spacer member, but mean that the spacer member may be disposed in an area between adjacent light sources when the light sources are seen at least from a direction perpendicular to the board. That is, for example, in the case of disposing a hollow spacer member in a gap between adjacent light sources, or in the case of bridging a plate-like spacer member over a gap between the adjacent light sources, the above effects can be obtained.

Although the spacer member may be disposed in only a gap between adjacent light sources, it will be more preferable to dispose the spacer member also in a gap between an inner surface of the guide member and a side surface of the light source.

According to this construction, since an exposed portion on the board can be decreased in an inner area of the guide member, a loss of reflected light can be reduced.

Although the spacer member is not limited to a particular configuration, it will be more preferable that the spacer member has a configuration that does not interfere with a light distribution area from the light sources.

According to this construction, it is possible to reflect the light reflected from the light guide plate or the guide member by the spacer member while the spacer member avoids interference with the lights irradiated to the light guide plate. That is, since it is possible to reduce a loss of the reflected light while avoiding a loss of the light irradiated from the light sources, it is possible to enhance brightness of illumination.

Although the guide member and spacer member are formed individually, it is particularly preferable that the guide member holds the light guide plate on the board, it is also preferable that the spacer member is integrated with the guide member.

According to this construction, since it is possible to enhance brightness of illumination while holding the light guide plate on the board by the guide member, it is possible to reduce a cost in comparison with a case of individual production of them.

According to the present invention, it is possible to enhance brightness of illumination by a few light sources.

### BRIEF DESCRIPTION OF THE DRAWINGS

Exemplary embodiments are described in detail below with reference to the drawings, in which the numerals, represent like parts, and wherein:

FIG. 1a is a front elevation view of audio equipment on which an embodiment of an illumination apparatus in accordance with the present invention is mounted;

FIG. 1b is a sectional view of the audio equipment taken along line B-B in FIG. 1a;

FIG. 2 is an exploded perspective view of the audio equipment shown in FIG. 1;

FIG. 3 is a rear side view of a holder shown in FIG. 2;

FIG. 4 is a front elevation view of an arrangement of LEDs and filler blocks shown in FIG. 2;

FIG. 4a is a front elevation view of an arrangement of LEDs and a filler plate shown in FIG. 2;

FIG. 5a shows the LEDs and filler blocks disposed to form the same plane with each other;

FIG. 5b shows the LEDs having slanted surfaces;

FIG. 6 is a graph illustrating brightness on a liquid crystal display upon mounting and dismounting the filler blocks; and

FIG. 7 is a perspective view taken from a rear side of a holder in another embodiment.

### DETAILED DESCRIPTION OF EMBODIMENTS

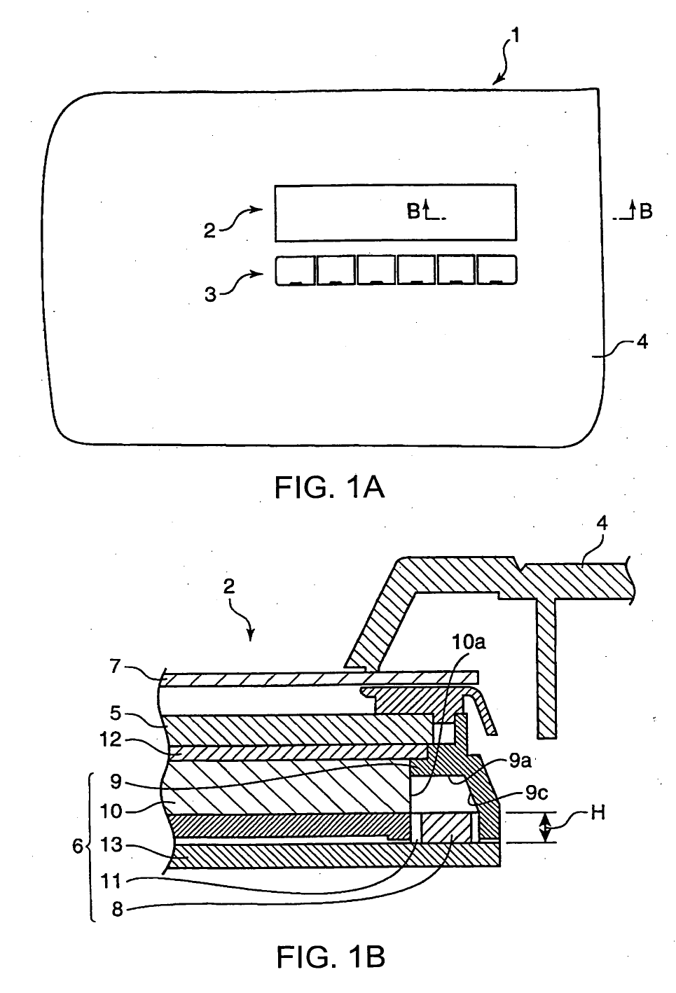

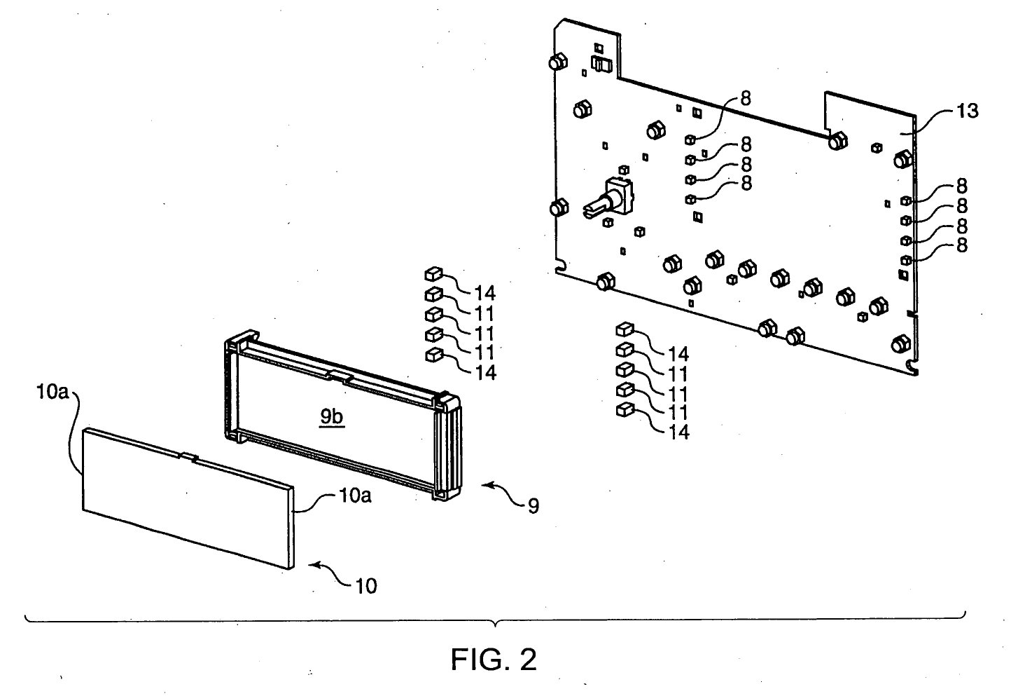

FIG. 1a is a front elevation view of an audio equipment on which an embodiment of an illumination apparatus in accordance with the present invention is mounted. FIG. 1bis a sectional view of the audio equipment taken along line B-B in FIG. 1a. FIG. 2 is an exploded perspective view of the audio equipment shown in FIG. 1.

An audio equipment 1 includes a liquid crystal display section 2 that displays various information, buttons 3 for selection of function, and a front panel 4 that accommodates the display section 2 and buttons 3 in an exposed state at a front side.

The liquid crystal display section 2 includes a liquid crystal display (hereinafter referred to “LCD”) panel 5, an illumination apparatus 6 that illuminates the rear side of the LCD panel 5 and a cover panel 7 directed toward a user (front side). Contents expressed by lights permeated through the LCD panel 5 are indicated through the cover plate 7.

In more detail, the LCD panel 5 includes a pair of glass plates and a liquid crystal sealed between the glass plates and forms an image corresponding to display contents by controlling light permeability of the liquid crystal when a voltage is applied to the liquid crystal.

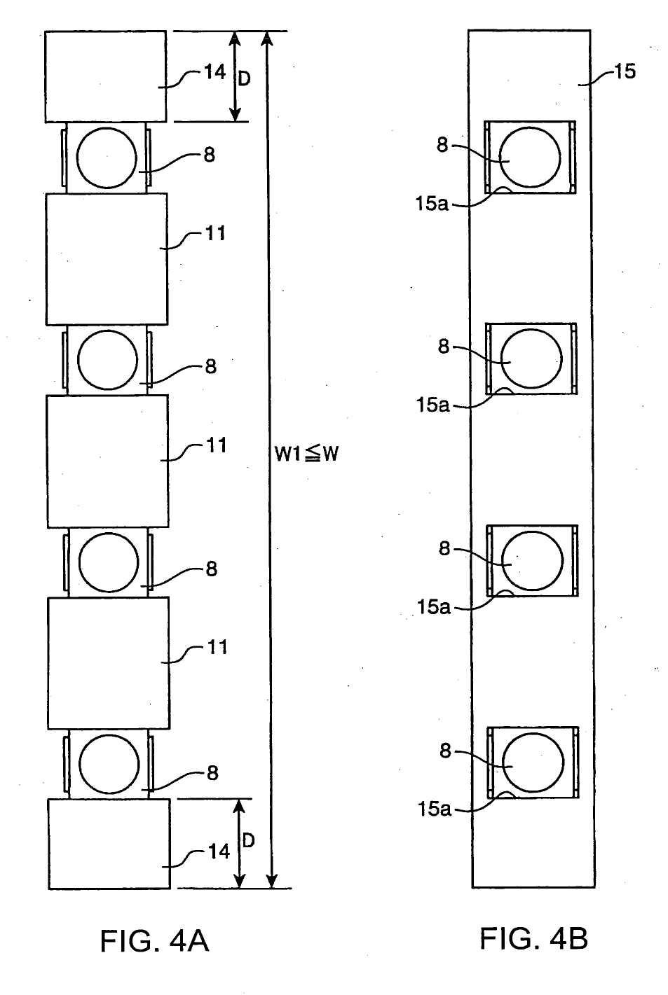

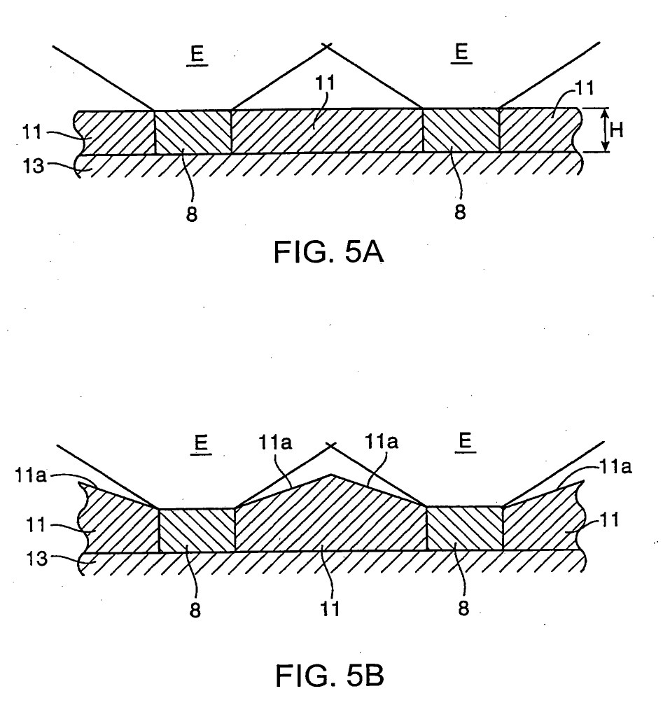

The depicted illumination apparatus 6 includes two sets of four LEDs (light emitting diodes) 8, which are an example of dot-like sources accommodated in a pair of containing cavities 9a in a holder (guide member) 9 to guide lights emitted from the respective LEDs 8 to side surfaces (incident surfaces) of a light guide plate 10. In the illumination apparatus 6, filler blocks (spacer members) 11 are disposed in gaps between adjacent LEDs 8 (see FIG. 4a and FIG. 5a). This construction can reflect the lights, which are irradiated to gaps between the adjacent LEDs 8 and reflected from the holder 9 or the light guide plate 10, to the light guide plate 10. Accordingly, the illumination apparatus 6 can suppress attenuation of the lights in the gaps between the adjacent LEDs 8.

In more detail, the illumination apparatus 6 includes a light guide plate 10 mounted through a color filter 12 on the rear side of an LCD panel 5, a holder 9 that holds the light guide plate 10, a printed board 13 to which the holder 9 is attached, eight LEDs 8 mounted on the printed board 13, filler blocks 1 1 and 14 (see FIG. 4a) adapted to close gaps between adjacent LEDs 8.

The light guide plate 10 is a substantially rectangular plate made of a material such as an acrylic resin or the like. Incident lights onto short sides, e.g., narrow surfaces 10a, of the plate 10 are subject to irregular reflection in the plate 10, thereby illuminating a front surface of the plate 10 substantially uniformly.

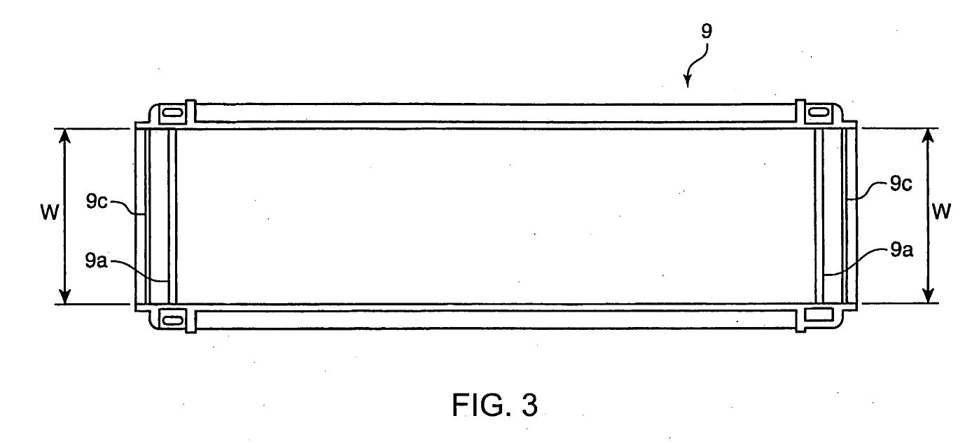

The holder 9 maybe formed into a frame-like configuration having a recess 9b (see FIG. 2) adapted to receive the light guide plate 10 at the front side. As shown in FIG. 1band FIG. 3, the holder 9 is provided along the opposite short sides with a pair of containing cavities 9a each extending from an inner side wall of the recess 9b in a generally L-shape and opening over the rear side of the holder 9. The containing cavities 9a accommodate a set of the LEDs 8 in series from the rear side, as described below. The containing cavities 9a maybe provided on the shoulder portion with a slant surface 9c that tapers toward the front side.

In the depicted embodiment eight LEDs 8 are arranged on the printed board 13 to be divided into two sets on two arrays (a set of four LEDs 8 are disposed in each array). These LEDs 8 emit, for example, white light mainly toward the front side of the illumination apparatus 6. As shown in FIG. 4a, three filler blocks 11 are secured in gaps between the adjacent LEDs 8 in an array on the printed board 13, while two filler blocks 14 are secured on the printed board 13 on the opposite outer ends of the LEDs 8.

The respective filler blocks 11 and 14 preferably include a material having a high reflection factor at least on the upper surface (front side surface). The respective filler blocks 11 and 14 in the present embodiment are preferably made of a polycarbonate resin having a high density. Preferable polycarbonate resins include YUPIRON (registered trade name) HR3001NR (1.34 g/cm³ in density) sold by Mitsubishi Engineering Co. Ltd., PANLIGHT (registered trade name) LD-1000RM (1.28 g/cm³in density) by from Teijinkasei Co. Ltd., or the like.

The respective filler blocks 11 and 14 in the present invention are preferably colored white.

Thus, since the respective filler blocks 11 and 14 are colored in white and made of a material having a high density, these pieces 11 and 14 can suppress absorption (attenuation) of light from the respective LEDs 8. Furthermore, a mirror finishing process is preferably applied to the surfaces of the respective filler blocks 11 and 14, thereby reflecting light and suppressing attenuation of the irradiated light.

Also, the respective filler blocks 11 and 14 preferably have substantially the same height H as that of each LED 8 (see FIG. 5a). Consequently, the respective LEDs 8 can emit light radially toward the front side without causing interference between a distribution area E of light and the filler blocks 11 and 14.

Moreover, as shown in FIG. 4a, a width D of each filler block 14 is preferably set so that an entire length W1 of an array of the LEDs 8 is smaller than or equal to a width W of the containing cavity 9a (see FIG. 3). Consequently, it is possible to accommodate the respective LEDs 8 and filler blocks 11 and 14 in the containing cavities 9a. Although the filler blocks 14 are provided in the present embodiment, the filler blocks 14 can be omitted, if the width W of the containing cavity 9a is previously set to be a dimension (W1-2D).

When the holder 9 is mounted on the printed board 13, a set of four LEDs 8 in an array are accommodated in each containing cavity 9a, as shown in FIG. 1b. Under this condition, when the LEDs 8 are lit, irradiating light illuminate the opposite side surfaces 10a of the light guide plate 10, thereby illuminating the front surface of the light guide plate 10.

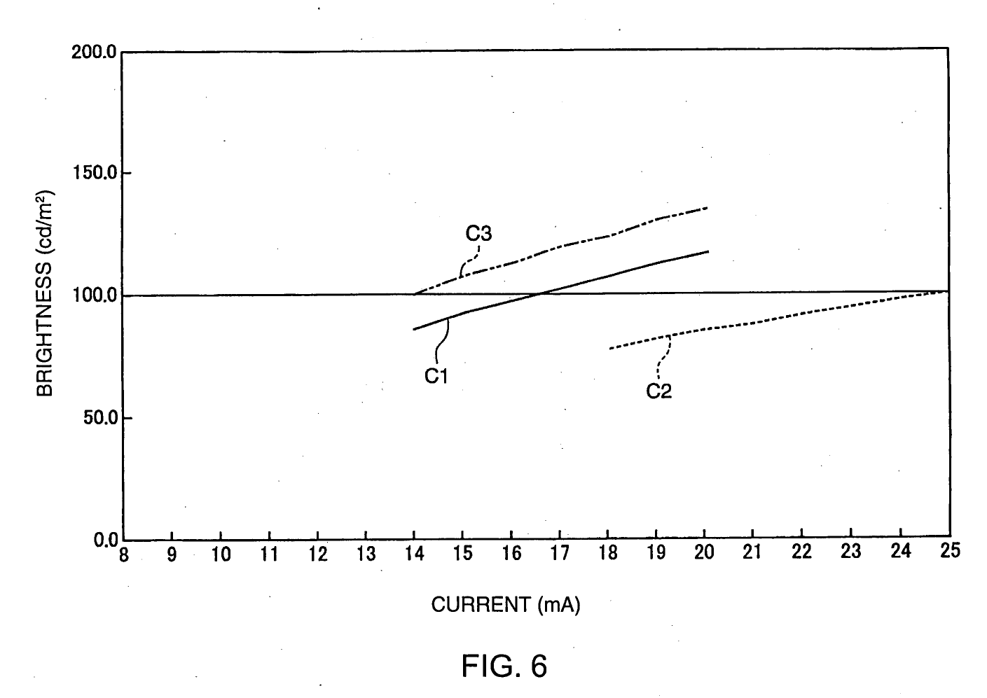

Referring to FIG. 6, brightness of illumination is compared between the case of providing the respective filler blocks 11 and 14 and in the case of providing no filler blocks will be explained below. The brightness in the following description defines brightness of light (white light) permeated through the LCD panel 5 in the case of setting light permeability of the LCD panel 5 to be a maximum value.

As shown in FIG. 6, the brightness C1 (full line in FIG. 6 and hereinafter referred to “mounting brightness”) in the case of mounting the respective filler blocks 11 and 14 on the printed board 13 is about 1.4 times the brightness C2 (dotted line in FIG. 6 and hereinafter referred to “non-mounting brightness”) in the case of mounting no pieces 11 and 14 on the printed board 13, if a supply current is constant. In more detail, if the supply current is 20 mA, the mounting brightness C1 is 116.2 cd/m² while the non-mounting brightness C2 is 84.7 cd/m².

C3 in FIG. 6 shows the brightness (hereinafter referred to “same material mounting brightness”) in the case where the holder 9 is made of the same material as the respective filler blocks 11 and 14 and an inner wall of the containing cavity 9a is subjected to a mirror finishing process. The same material mounting brightness C3 is about 1.2 times the mounting brightness C1 (about 1.6 times the non-mounting brightness C2), if the supply current is constant. In more detail, if the supply current is 20 mA, the same material mounting brightness C3 is 134.6 cd/m².

It is preferable in the technical field of liquid crystal display to set brightness of characters to be more than or equal to 100 cd/m², if a background is darkened and the characters are displayed in white. Accordingly, if the characters are displayed at a brightness of more than or equal to 100 cd/m², the non-mounting brightness C2 requires a current of 25 mA, the mounting brightness C1 requires a current of 17 mA, and the same material mounting brightness C1 requires a current of 14 mA. It is possible to save on consumption of electrical power.

In other words, it is possible to reduce the number of the LEDs 8 in the case of making brightness more than or equal to 100 cd/m² to less than the number of the LEDs 8 in the case of mounting no filler blocks 11 and 14, if the supply current is constant in the illumination apparatus 6 described above.

As described above, it is possible to suppress the light irradiated from the respective LEDs 8 from leaking out from the containing cavities 9a, since the light irradiated from the LEDs 8 is guided along the containing cavities 9a to the side surfaces 10a of the light guide plate 10 in the illumination apparatus 6.

Furthermore, since the light irradiated in the gaps between the adjacent LEDs 8 and reflected from the holder 9 or the light guide plate 10 can be reflected by the respective filler blocks 11 in the illumination apparatus 6, it is possible to irradiate again a part of the reflected light to the light guide plate 10, thereby reducing the loss of the reflected light in the gaps between the adjacent LEDs 8.

Accordingly, the above described illumination apparatus 6 can enhance brightness of illumination (light guide plate 10) while using a fewer LEDs 8.

It is possible to reduce the loss of the reflected light, since an exposed area of the printed board 13 in the containing cavities 9a is further reduced by the construction in which the filler blocks 14 close the gaps between the inner walls of the containing cavities 9a and the side surfaces of the LEDs 8 as well as the gaps between the adjacent LEDs 8.

In the above embodiment, the filler blocks 14 close the gaps between the inner walls of the containing cavities 9a and the side surfaces of the LEDs 8. However, the invention is not limited to this configuration. For example, as shown in FIG. 4b, a filler plate 15 may be provided.

The filler plate 15 is provided with a plurality of through-holes 15a corresponding to a layout of the respective LEDs 8 on the printed board 13. The respective LEDs 8 are received in the respective through-holes 15a and the filler plate 15 is received in the containing cavities 9a so that the gaps between the adjacent LEDs 8 and between the side surfaces of the respective LEDs 8 and the inner walls of the containing cavities 9a are closed.

According to this embodiment, it is possible to eliminate the exposed area of the printed board 13 in the containing cavities 9a and to further reduce the loss of the reflected light, since the filler plate 15 can close not only the gaps between the adjacent LEDs 8 but also the gaps between the side surfaces of the respective LEDs 8 and the inner walls of the containing cavities 9a. Moreover, according to this construction, it is possible to enhance workability, since a single filler plate 15 is attached to the containing cavities 9a to close the gaps between the adjacent LEDs 8.

It is possible for the filler blocks 11 or the filler plate 15 to reflect the reflected light from the light guide plate 10 or the holder 9 while the filler blocks 11 or the filler plate 15 do not interfere with the reflected light, if a height of each filler block 11 or the filler plate 15 is set to be substantially the same as that of each LED 8 in order to restrict the filler blocks 11 or the filler plate 15 from interfering with the light distribution area E of the respective LEDs 8. That is, since it is possible to reduce the loss of the reflected light while avoiding the loss the light irradiated from the respective LEDs 8, the brightness of illumination can be further enhanced.

Moreover, as shown in FIG. 5b, the filler blocks 11 or the filler plate 15 can be provided with a tapered slant surface 11 a so as to avoid interference with the light distribution area E.

Since the tapered slant surface 11a can reflect the reflected light from the holder 9 or the light guide plate 10 in the vicinity of the light guide plate 10, it is possible to effectively reduce the loss of the reflected light.

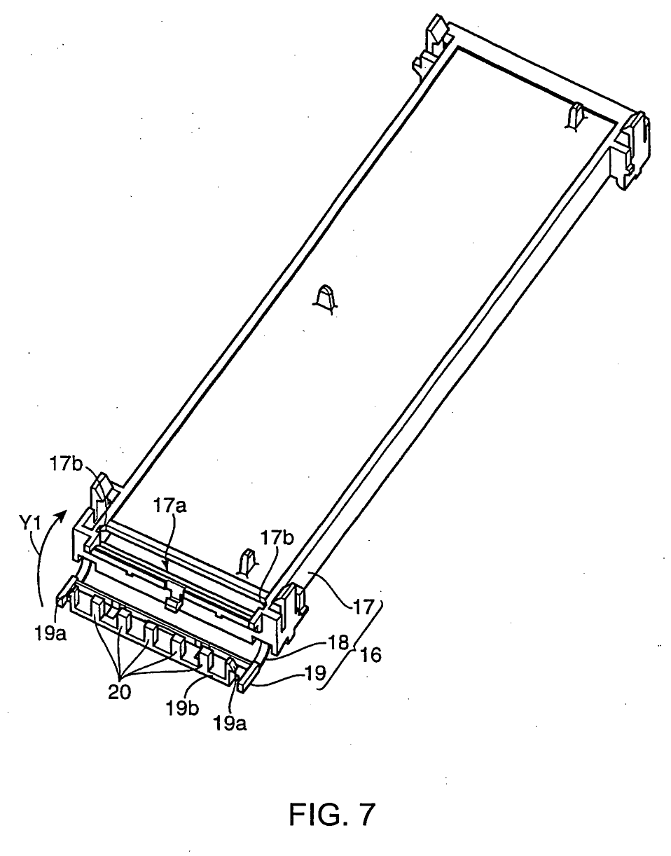

Although spacer members such as the filler blocks 11 and 14 or a spacer member such as the filler plate 15 are separated from a guide member such as the holder 9 in the above described embodiment, they may be integrated together, as shown in FIG. 7.

A holder 16 in this embodiment has a holder body 17 integrated together with a lid body 19 through a hinge 18.

The holder body 17 is provided with a containing section 17a that is opened at a rear side and a lateral side with an opening area that can contain six LEDs 8 in an array together.

When the lid body 19 is mounted on the side surface of the holder 17 by deflecting the hinge 18 in a direction shown by an arrow Y1, a side wall 19b of the lid body 19 closes the side space of the containing section 17a to define a cavity corresponding to the containing cavity 9a between the holder 17 and the lid body 19. In more detail, when latch pawls 19a engage latch recesses 17b in the holder body 17, the lid body 19 is mounted on the holder body 17.

Furthermore, the lid body 19 includes five spacer portions 20 that extend from the side wall 19b to the containing section 17a in a comb-teeth-like configuration when the lid body 19 is mounted on the holder body 17. The spacer portions 20 are arranged in connection with the intervals between the respective LEDs 8 and inserted laterally into the gaps between the adjacent LEDs 8 when the lid is mounted on the holder body 17. Also, the spacer portions 20 preferably have a thickness to define the same plane as the respective LEDs 8 (that is, height H in FIG. 5)

Since the holder 16 holds the light guide plate 10 on the printed board 13 to enhance brightness of illumination in the illumination apparatus 6 of this embodiment, it is possible to decrease the cost in comparison with the case of separated members.

Although the above described embodiment utilizes the illumination apparatus 6 as a backlight for the LCD panel 5, an object to be illuminated is not limited to the LCD. For example, it is possible to utilize the illumination apparatus 6 in order to display certain information (for example, information to visually confirm if the button 3 is pushed down or not, or information indicating a function of the button 3) on the front side by irradiating the button 3 at the rear side and passing lights through an aperture in the button 3.

Although the LEDs 8 irradiate the side surfaces 10a of the light guide plate 10 at the opposite sides in the above described embodiment, the LEDs 8 may irradiate either side surface 10a concentrically, or on the contrary the LEDs 8 on plural arrays may irradiate the light guide plate 10 from plural directions. That is, an arrangement of the respective LEDs 8 can be selected in accordance with the number of incident surfaces to be set on the light guide plate 8. The number of the LEDs 8 is not limited.

Furthermore, although the respective LEDs 8 are disposed on the printed board 13 so that the lights are directed to the front side in the above described embodiment, they may be disposed on the printed board 13 so that lights are directed horizontally to the side surfaces 10a of the light-guiding plane 10.

While the invention has been described with reference to specific embodiments, these embodiments should be viewed as illustrative and not limiting. Various changes, substitutes in property or the like are possible within the spirit and scope of the invention.

What is claimed is:

1. An illumination apparatus comprising:
a light guide plate having an incident surface;
a plurality of light sources, disposed on a substrate, that irridate light on the incident surface, incident light from the light sources illuminating a front surface of the light guide plate;
a guide member disposed between the incident surface of the light guide plate and the substrate and surrounding the light sources and light paths of the light sources; and
a spacer member that closes a gap between adjacent light sources;
wherein the spacer member reflects a part of reflected light at least from the light guide plate or the guide member among the light irradiated from the light sources.

2. An illumination apparatus according to claim 1,
wherein the spacer member is disposed also in a gap between an inner surface of the guide member and a side surface of the light source.

3. An illumination apparatus according to claim 1,
wherein the spacer member has a configuration that does not interfere with a light distribution area from the light sources.

4. An illumination apparatus according to claim 1,
wherein the guide member holds the light guide plate on the substrate and the spacer member is integrated with the guide member.
